(19) United States
(12) Patent Application Publication
(10) Pub. No.: US 2016/0079673 A1
(43) Pub. Date: Mar. 17, 2016

(54) Chip Antenna Module

(71) Applicant: Sage Elephant Tech Co., Ltd., Hsinchu City (TW)

(72) Inventor: Hung-Hsien Chiu, Hsinchu City (TW)

(21) Appl. No.: 14/487,048

(22) Filed: Sep. 15, 2014

(51) Int. Cl. H01Q 9/04

(52) U.S. Cl. CPC H01Q 9/0442

(57) ABSTRACT

A chip antenna module is provided for use with an electronic device. The antenna module includes an insulation section arranged on a metal layer and the insulation section forms a non-metal closed area. A radiation resonance section is arranged in the insulation section. The radiation resonance section includes negative and positive radiation resonators. A negative electrode path is slightly less than a quarter wavelength of a predetermined low frequency in order to resonate with the low frequency. The negative radiation resonator distal end section is arranged to resonate with a predetermined high frequency. The positive radiation resonator is arranged to resonate with a predetermined high frequency. By coupling the positive radiation resonator with the negative radiation resonator, antenna impedance can be adjusted. The present invention has a simple structure, greatly reduces the antenna size, and allows for receiving and transmission of wireless signals of multiple frequencies.

### BACKGROUND OF THE INVENTION

(a) Technical Field of the Invention

The present invention generally relates to an antenna used in an electronic device for wireless communication de, and more particularly to a chip antenna module.

(b) Description of the Prior Art

Electronic devices, such as portable computers, handheld electronic devices, wearable electronic devices, and wireless signal devices. Such devices are often provided with functions of wireless communication and satellite positioning, such as communication carried out with WiFi using 2.4 GHz and 5 GHz and Bluetooth and ZeeBee using 2.4 GHz and satellite positioning achieved with GPS (Global Positioning System) using 1.575 GHz.

The interior space of electronic devices is increasingly reduced. However, the size of a regular antenna is relatively large, making the product design increasingly difficult. If a high dielectric material is used to help reduce the overall size of an antenna, then the antenna needs to keep a relatively large insulation area in view of the characteristics thereof or tuning of the antenna in respect of multiple frequencies is difficult. FIG. 1 of the attached drawings illustrates an example of such type of antenna.

Thus, the present invention aims to overcome such problems by proposing an improved multi-frequency chip antenna module that is applicable to a wireless electronic device.

### SUMMARY OF THE INVENTION

In view of the above-discussed drawbacks of the known antennas, an object of the present invention is to provide a chip antenna module, which is installable in an electronic device featuring wireless communication in order to overcome the drawbacks of conventional antenna modules, such as requiring a large insulation area and being difficult for antenna tuning for multiple frequencies.

The present invention provides a chip antenna module, which comprising: a metal layer, an insulation section, a radiation resonance section, and the signal feeding source. The antenna module is structured to have the insulation section arranged on the metal layer and the insulation section forms a non-metal closed area. The radiation resonance section is arranged in the insulation section. The radiation resonance section comprises a negative radiation resonator and a positive radiation resonator. The negative radiation resonator comprises a grounding section that is electrically connected to the metal layer. The positive radiation resonator is electrically connected to the signal feeding source. A first path is defined as extending from a negative radiation resonator distal end section to the grounding section and a second path is defined as extending from the grounding section along an insulation section periphery to a signal feeding source grounding section. The sum of the lengths of the two paths is slightly less than a quarter wavelength of a predetermined low frequency in order to resonate with the predetermined low frequency. The negative radiation resonator distal end section is arranged to resonate with a predetermined high frequency. The positive radiation resonator is arranged to resonate with a predetermined high frequency. By coupling the positive radiation resonator with the negative radiation resonator, the antenna impedance can be adjusted.

The insulation section comprises an insulation material that is one of a rigid printed circuit board, a flexible printed circuit board, a high dielectric material, and a plastic material, or a composite material of a combination thereof. The metal layer, the negative radiation resonator, and the positive radiation resonator are arranged on a carried that comprises the insulation material of the insulation section.

The positive radiation resonator can be an electrical capacitive element, an electrical inductive element, a plate-like conductor element, or a conductor wire.

The signal feeding source can be a coaxial cable, a RF connector, or a microstrip transmission line.

With the above described structure and assembly of the components, the present invention provides a chip antenna module that has a simple structure and greatly reduces the size for receiving and transmitting wireless electrical wave signals of multiple frequencies.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a conventional chip antenna module.

FIG. 2 is a plan view showing a chip antenna module according to the present invention.

FIG. 3 is a schematic view showing a low frequency path of the chip antenna module according to the present invention.

FIG. 4 is a schematic view showing a pre-formed solder pad on the chip antenna module according to the present invention.

FIG. 5A is a schematic view illustrating a signal feeding source formed of a coaxial cable according to the present invention.

FIG. 5B is a schematic view illustrating a signal feeding source formed of or connected to a radio frequency (RF) connector according to the present invention.

FIGS. 5C, 5D, 5E, and 5F are schematic views illustrating signal feeding sources formed of various types of microstrip according to the present invention.

FIG. 5G is a plan view illustrating a signal feeding source formed of a microstrip according to the present invention.

FIG. 6 is a perspective view showing a stand-alone assembled body that is formed by pre-assembling an insulation section and a radiation resonant section together according to the present invention.

FIG. 7 is a perspective view showing a stand-alone assembled body that is formed by pre-assembling an insulation section and a radiation resonant section together according to another embodiment of the present invention.

FIG. 8 is a perspective view illustrating conductive vias extending through the insulation section and electrically connecting between a metal layer and the signal feeding source according to the present invention.

FIG. 9 is a perspective view illustrating conductive vias extending through the insulation section and electrically connecting between a metal layer and the signal feeding source according to another embodiment of the present invention.

FIG. 10 is a perspective view showing a stand-alone assembled body that is formed by pre-assembling an insulation section and a radiation resonant section together according to a further embodiment of the present invention.

FIG. 11 shows a VSWR (Voltage Standing Wave Ratio) diagram of two frequencies for a test of the chip antenna module according to the present invention.

FIG. 12 shows a VSWR (Voltage Standing Wave Ratio) diagram of a single frequency for a test of the chip antenna module according to the present invention.

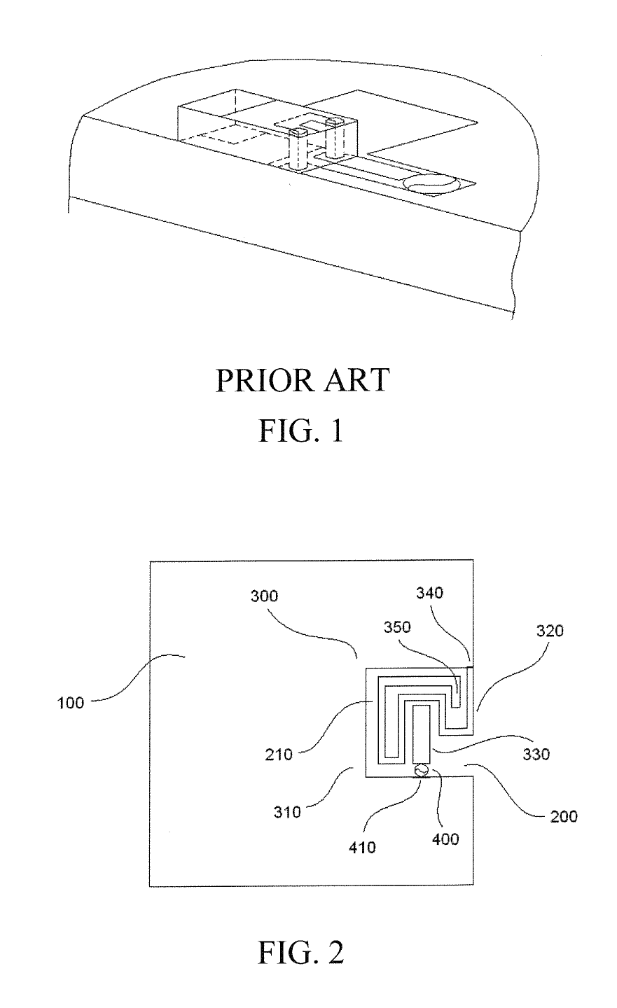

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention provides a chip antenna module 300, which, as shown in FIG. 2, comprises: a metal layer 100, an insulation section 200, a radiation resonance section 310, and a signal feeding source 400. The insulation section 200 is formed on the metal layer 100 and the insulation section 200 forms a non-metal closed area. A radiation resonance section 310 is arranged in the insulation section 200.

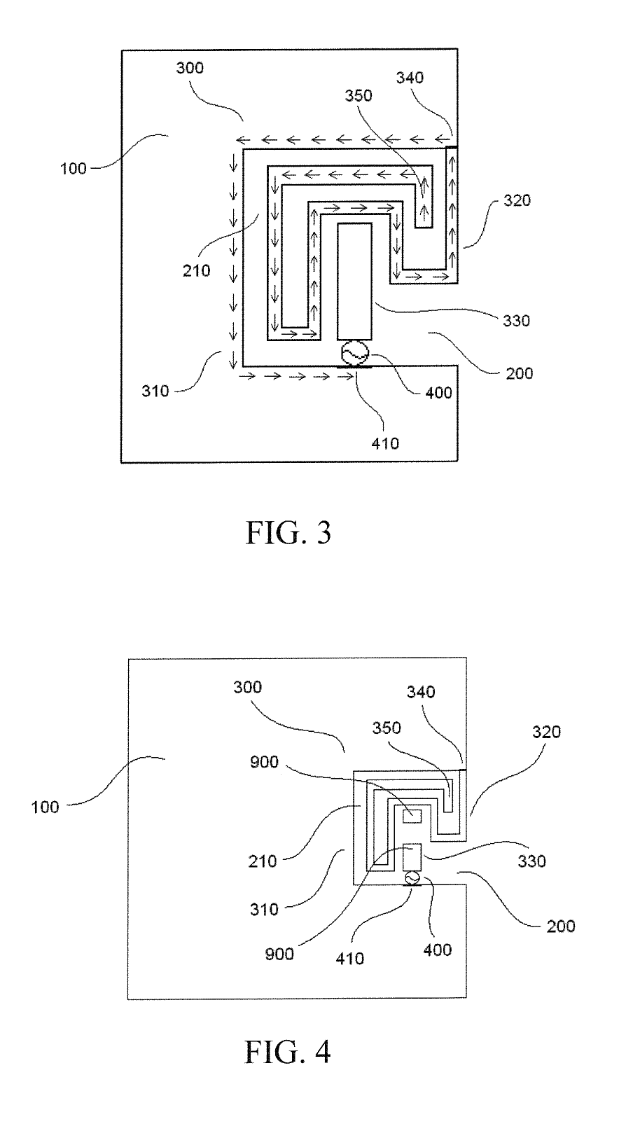

The radiation resonance section 310 comprises a negative radiation resonator 320 and a positive radiation resonator 330. The negative radiation resonator 320 comprises a negative radiation resonator pounding section 340, which is electrically connected to the metal layer 100. The positive radiation resonator 330 is electrically connected to the signal feeding source 400. A first path is defined as extending from a negative radiation resonator distal end section 350 to the negative radiation resonator grounding section 340 and a second path is defined as extending from the negative radiation resonator grounding section 340 along an insulation section periphery 210 to a signal feeding source grounding section 410. The sum of the lengths of the two paths is slightly less than a quarter wavelength of a predetermined low frequency in order to resonate with the predetermined low frequency. The entire path is illustrated by arrows shown in FIG. 3. Further, the negative radiation resonator distal end section 350 is arranged to resonate with a predetermined high frequency, and the positive radiation resonator 330 is also arranged to resonate with a predetermined high frequency. Thus, by coupling the positive radiation resonator 330 with the negative radiation resonator 320, it is possible to adjust the impedance of the chip antenna module 300.

The insulation section 200 can be made of a rigid printed circuit board (PCB), a flexible printed circuit board (FPCB), a high dielectric material, or a plastic material, or a composite material formed of a combination of any of the above listed materials. The metal layer 100, the negative radiation resonator 320, and the positive radiation resonator 330 are arranged on a carrier that is formed of the above named insulation material of the insulation section 200.

The positive radiation resonator 330 can be an electrical capacitive element, an electrical inductive element, a plate-like conductor element, or a conductor wire. The positive radiation resonator 330 can be mounted on the chip antenna module according to the present invention by means of surface mounting technology (SMT), and thus a solder pad 900 may be pre-formed on the insulation section 200 under the positive radiation resonator 330, as shown in FIG. 4.

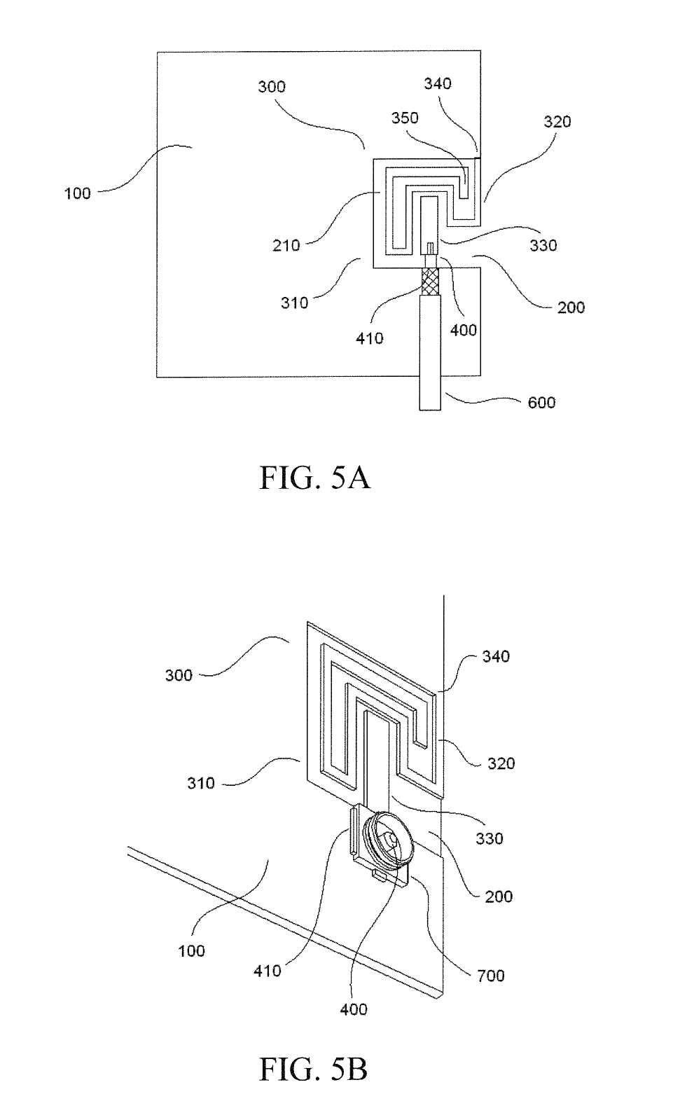

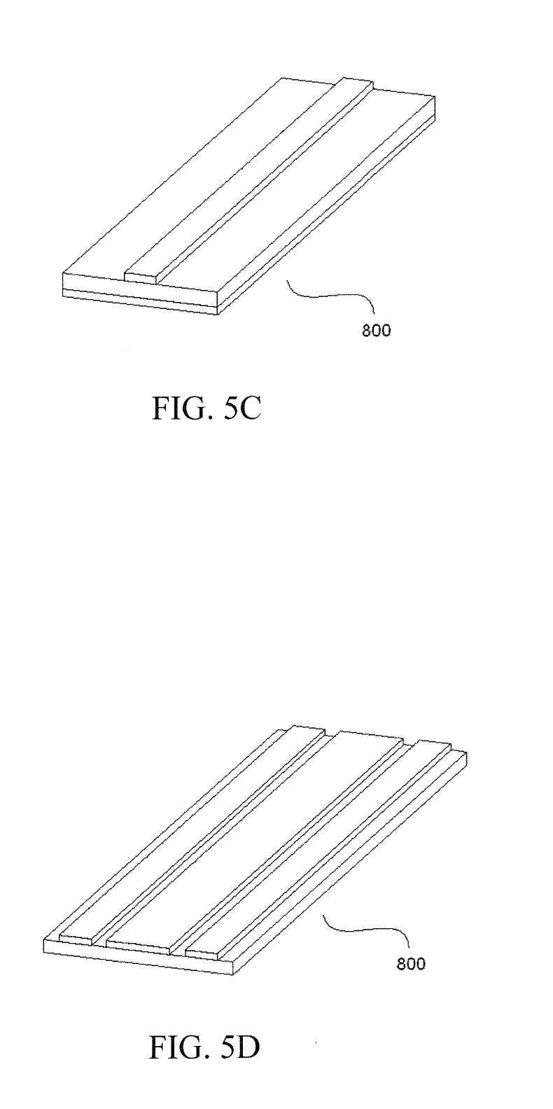

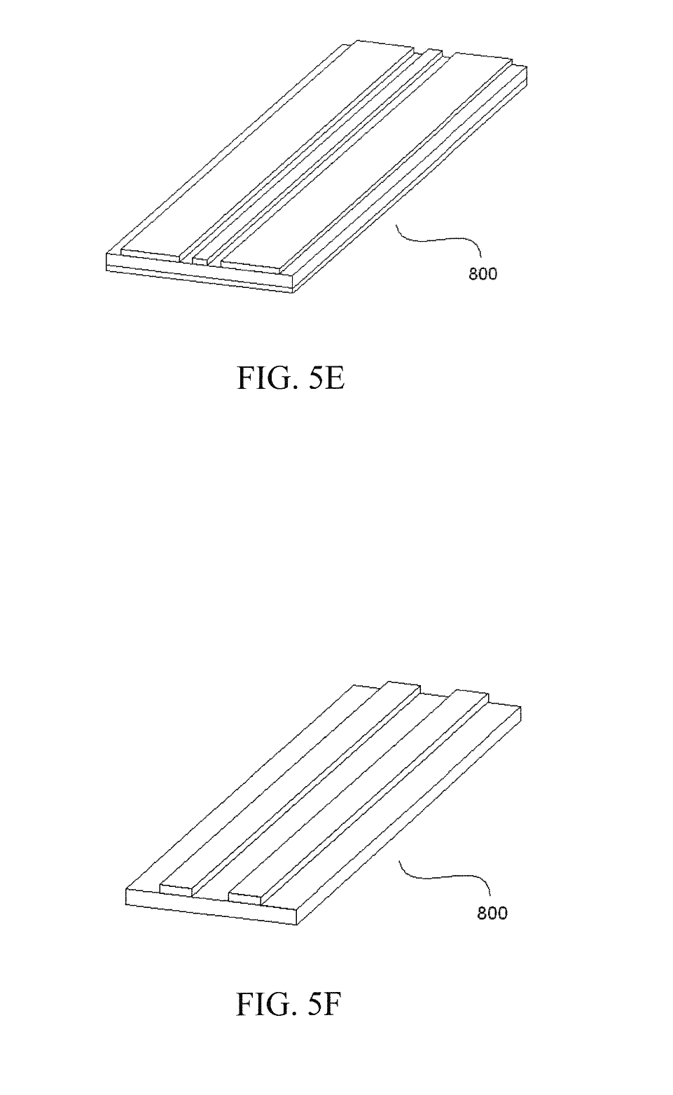

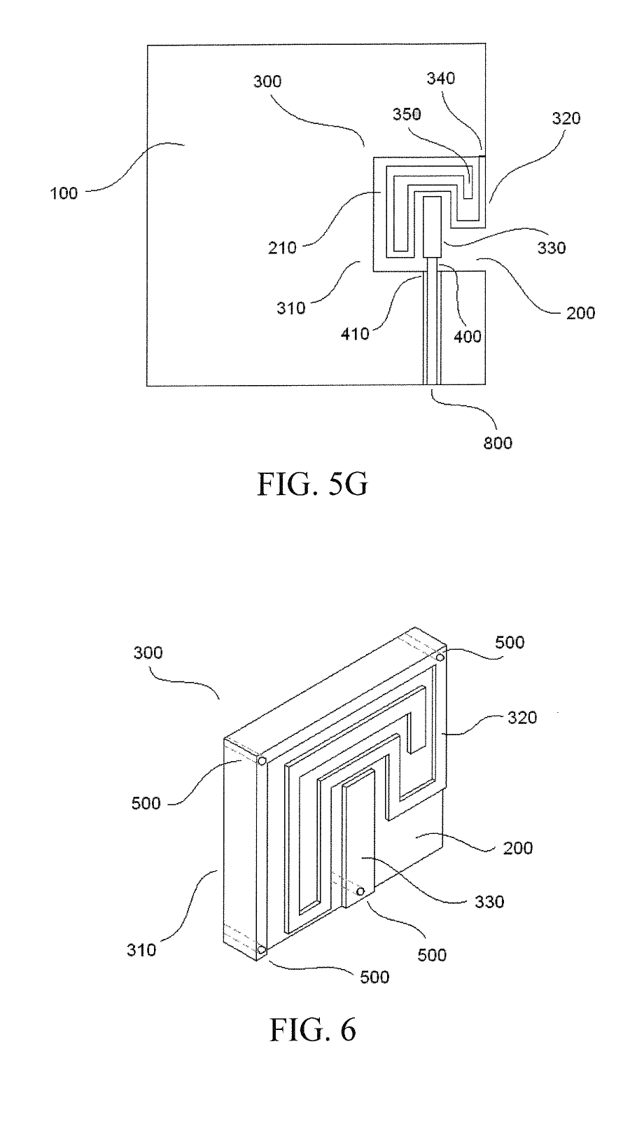

The chip antenna module 300 according to the present invention may be used with various types of signal feeding source 400. Examples of such types of the signal feeding source 400 include for instance a coaxial cable 600 shown in FIG. 5A, a radio frequency (RF) connector shown in FIG. 5B, and various types of microstrip transmission line 800 shown in FIGS. 5C, 5D, 5E, and 5F. FIG. 5G is a schematic view particularly showing an example in which a microstrip transmission line 800 is used to serve as a signal feeding source 400. The coaxial cable 600, the RF connector 700, and the microstrip transmission line 800 that are mentioned above are well known and widely used in the field of electronics and unnecessary description will be omitted here.

The chip antenna module 300 according to the present invention may be structured in such a way that a metal element of an existing electronic device is used as the metal layer 100 of the chip antenna module 300 of the present invention; or alternatively, an independent metal layer 100 is used to receive the insulation section 200 and the radiation resonance section 310 to arranged thereon, both achieving the same effect.

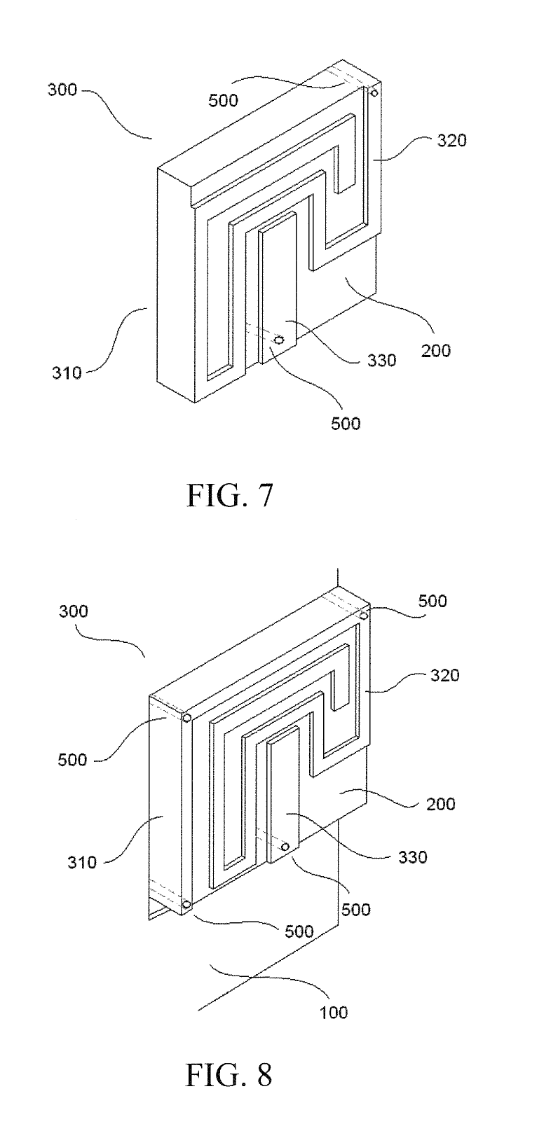

Further, to facilitate installation of the chip antenna module 300 of the present invention in an electronic device, the insulation section 200 and the radiation resonance section 310 can be manufactured and assembled together in advance as an assembled body, as shown in FIGS. 6 and 7 and the insulation section 200 comprises conductive vias 500 extending therethrough for electrical connection with the negative radiation resonator 320 and the positive radiation resonator 330.

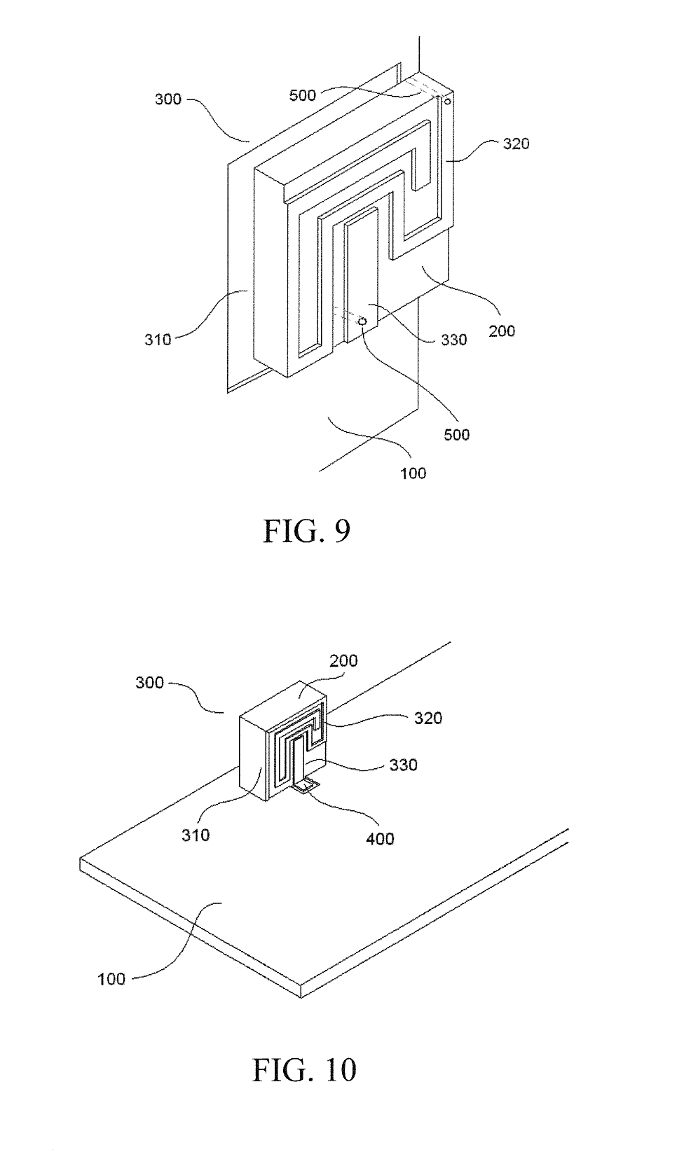

FIGS. 8, 9, and 10 show examples of the assembled body composed of the insulation section 200 and the radiation resonance section 310, in which the chip antenna module 300 is laid flat on or erected upward on the metal layer 100. The conductive vias 500 are arranged to electrically connect the negative radiation resonator 320 to the metal layer 100 and to electrically connect the positive radiation resonator 330 to the signal feeding source 400. In a different embodiment, where no conductive vias 500 is provided, an edge of the negative radiation resonator 320 is set to directly and electrically connect with the metal layer 100 and an edge of the positive radiation resonator 330 is set to directly and electrically connect with the signal feeding source 400.

In summary, the chip antenna module 300 according to the present invention has a simple structure and can greatly reduce the antenna size, and is applicable to various electronic device environments to help introduce products for receiving and transmitting wireless electrical wave signals in multiple frequencies.

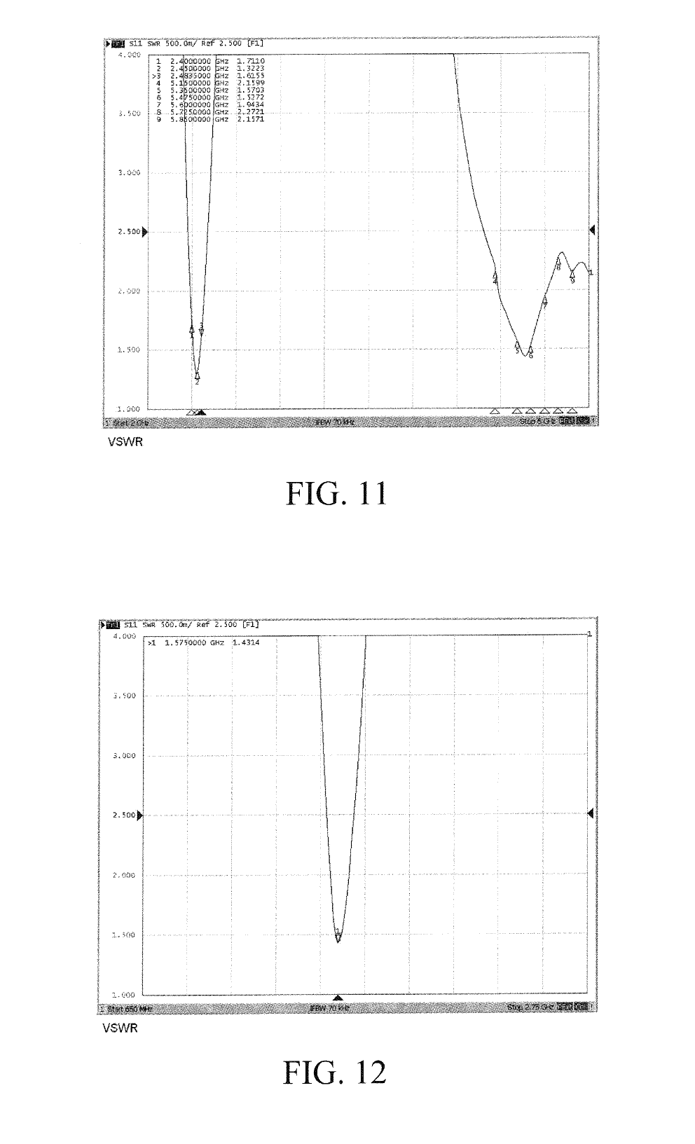

The chip antenna module 300 of the present invention can be formed as a single-frequency-band or multiple-frequency-band antenna that covers a desired communication frequency band, as shown in FIG. 11, wherein the chip antenna module 300 of the present invention is shown applied to communication for WiFi in 2.4 GHz and 5 GHz and Bluetooth and ZeeBee in 2.4 GHz, or as shown in FIG. 12, wherein the present invention is applied to satellite positioning with GPS (Global Positioning System) in 1.575 GHz.

The VSWR (Voltage Standing Wave Ratio) data illustrated in the diagrams show that the chip antenna module 300 of the present invention has a variety of advantages, such as diversified selection of material, fast design, fast installation, and excellent performance.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A chip antenna module, which comprises an insulation section arranged on a metal layer, the insulation section forming a non-metal closed area, a radiation resonance section being arranged in the insulation section, the radiation resonance section comprising a negative radiation resonator and a positive radiation resonator, the negative radiation resonator comprising a negative radiation resonator grounding section, which is electrically connected to the metal layer, the positive radiation resonator being electrically connected to the signal feeding source, a first path being defined as extending from a negative radiation resonator distal end section to the negative radiation resonator grounding section and a second path being defined as extending from the negative radiation resonator grounding section along an insulation section periphery to a signal feeding source grounding section, a sum of lengths of the first and second paths being slightly less than a quarter wavelength of a predetermined low frequency in order to resonate with the predetermined low frequency, the negative radiation resonator distal end section being arranged to resonate with a predetermined high frequency, the positive radiation resonator being arranged to resonate with a predetermined high frequency, whereby by coupling the positive radiation resonator with the negative radiation resonator, an antenna impedance is adjustable.

2. The chip antenna module as claimed in claim 1, wherein the insulation section comprises an insulation material selected from a rigid printed circuit board (PCB), a flexible printed circuit board (FPCB), a high dielectric material, and a plastic material, or a composite material of a combination thereof, the metal layer, the negative radiation resonator, and the positive radiation resonator being arranged on a carrier comprising the insulation material.

3. The chip antenna module as claimed in claim 1, wherein the signal feeding source comprises one of a coaxial cable, a radio frequency (RF) connector, and a microstrip transmission line.

4. The chip antenna module as claimed in claim 1, wherein the positive radiation resonator comprises one of an electrical capacitive element, an electrical inductive element, a plate-like conductor element, and a conductor wire.

5. The chip antenna module as claimed in claim 1, wherein the positive radiation resonator is mounted by means of surface mounting technology and a solder pad is pre-formed on the insulation section under the positive radiation resonator.

6. The chip antenna module as claimed in claim 1, wherein the metal layer comprises a metal element of an electronic device or is an independent metal layer.

7. The chip antenna module as claimed in claim 1, wherein the insulation section and the radiation resonance section are pre-assembled as an assembled body, which is arranged on the metal layer, the negative radiation resonator being electrically connected to the metal layer, the positive radiation resonator being electrically connected to the signal feeding source.
